(19) United States
(12) Patent Application Publication
(10) Pub. No.: US 2008/0086816 A1
(43) Pub. Date: Apr. 17, 2008

(54) PATIENT POSITIONING SYSTEM

(75) Inventor: Asghar Ali Farooqui, Bangalore (IN)

Correspondence Address: PETER VOGEL;GE HEALTHCARE, 3000 N. GRANDVIEW BLVD., SN-477, WAUKESHA, WI, 53188, US

(73) Assignee: GENERAL ELECTRIC COMPANY, Schenectady, NY (US)

(21) Appl. No.: 11/549,752

(22) Filed: Oct. 16, 2006

(51) Int. Cl. A61G 7/012

(52) U.S. Cl. 5/601; 5/611

(57) ABSTRACT

An embodiment provides a patient positioning system for an imaging device. The patient positioning system comprises a table assembly for engaging and supporting a patient, at least one single cross bar assembly coupled to the table assembly and a belt drive assembly coupled to the single cross bar assembly, the belt drive assembly being configured to drive the single cross bar assembly. Another embodiment provides a patient positioning system comprising a table assembly and at least two multiple cross bar assemblies coupled to the table assembly. The table assembly is configured to be displaced to multiple positions along a vertical axis. The multiple cross bar assembly comprises multiple pair of cross bars coupled to one another by a pivot. The patient positioning system can further comprise a screw drive assembly coupled to the multiple cross bar assembly for driving the multiple cross bar assembly.

### FIELD OF INVENTION

This invention relates generally to a patient positioning system and more particularly to a patient positioning system for an imaging device.

### BACKGROUND OF THE INVENTION

Generally, patient positioning systems are used to support and engage patients when they are being imaged by imaging devices. Conventional patient positioning systems typically comprise a table assembly and a drive assembly coupled to the table assembly. The patient positioning systems can further comprise a cross bar assembly connecting the drive assembly to the table assembly. Conventional drive assemblies configured for converting a rotary motion to a linear motion typically comprise one or more hydraulic cylinders to activate the function of the cross bar assembly. The hydraulic cylinders used in the drive assembly function at high pressures on sliding seal principal. The primary limitation in the drive assembly comprising the hydraulic cylinders is that the hydraulic cylinders require a complex control system and are bulky and prone to leakages. The movement of the table assembly driven by the hydraulic cylinders is discrete and is restricted to only two positions namely a collapsed position and an extended position. Further, the initial collapsible height of the table assembly driven by the hydraulic cylinders is large.

Hence there exists a need to provide a patient positioning system comprising a simpler and robust mechanism for displacing the table assembly with an enhanced reliability and cost savings.

### BRIEF DESCRIPTION OF THE INVENTION

The above-mentioned shortcomings, disadvantages and problems are addressed herein which will be understood by reading and understanding the following specification.

An embodiment provides a patient positioning system for an imaging device. The patient positioning system comprises a table assembly for engaging and supporting a patient, at least one single cross bar assembly coupled to the table assembly and a belt drive assembly configured to drive the single cross bar assembly. Further, the table assembly can be configured to be displaced to multiple positions along a vertical axis.

Another embodiment provides a patient positioning system comprising a table assembly and at least two multiple cross bar assemblies coupled to the table assembly. Each multiple cross bar assembly comprises multiple pairs of cross bars coupled to one another by a pivot. The patient positioning system can comprise a screw drive assembly coupled to the multiple cross bar assembly, the screw drive assembly being configured to drive the multiple cross bar assembly.

Yet another embodiment provides a patient positioning system comprising a table assembly for engaging and supporting a patient, at least one cross bar assembly coupled to the table assembly and one of a belt drive assembly and a screw drive assembly coupled to the cross bar assembly. The belt drive assembly and the screw drive assembly are configured to drive the cross bar assembly wherein the cross bar assembly is one of a single cross bar assembly and a multiple cross bar assembly.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 shows a schematic diagram of a patient positioning system for an imaging device in an embodiment of the invention;

FIG. 2 shows a schematic diagram of a patient positioning system comprising a table assembly in a collapsed condition in an embodiment of the invention;

FIG. 3 shows a schematic diagram of a patient positioning system comprising a table assembly in an extended condition in another embodiment of the invention;

FIG. 4 shows a schematic diagram of a patient positioning system comprising a belt drive assembly in yet another embodiment of the invention;

FIG. 5 shows a schematic diagram of a patient positioning system comprising a screw drive assembly in an embodiment of the invention; and

FIG. 6 shows a schematic diagram of a patient positioning system comprising a screw drive assembly in another embodiment of the invention.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

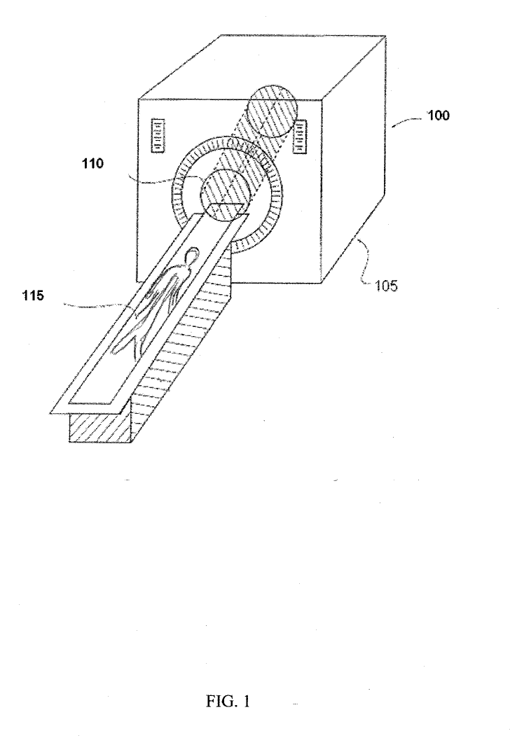

FIG. 1 shows a schematic diagram of an example of an imaging device 100. The imaging device 100 can be one of a computed tomography device, a positron emission tomography device, a magnetic resonance imaging device, an ultrasound-imaging device and an x ray device. One skilled in the art will however appreciate that, the examples of the imaging device 100 are not limited to the examples mentioned above and the invention shall have full scope of the claims.

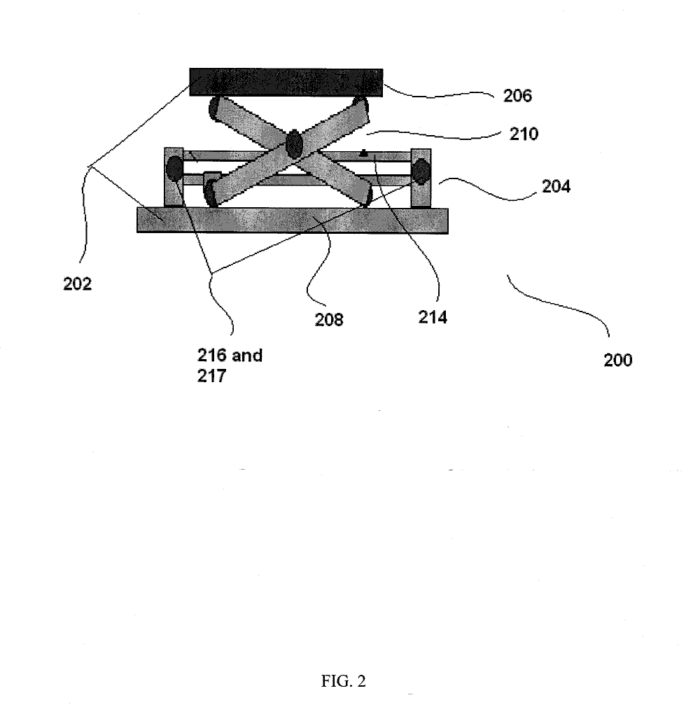

The imaging device 100 comprises an imaging gantry 105 that includes a bore or tunnel 110 for receiving a patient 115. In one embodiment as shown in FIG. 2, a patient positioning system 200 for positioning the patient 115 in the imaging gantry 105 is provided. The patient positioning system 200 comprises a table assembly 202 and a belt drive assembly 204 configured to drive the table assembly 202. The table assembly 202 comprises a table top 206 for engaging and supporting a patient and a table base 208. The table assembly 202 is configured to be displaced to multiple positions along a vertical axis, thereby raising and lowering the patient 115 supported by the table top 206. The patient positioning system 200 can further comprise structural members such as a single cross bar assembly 210 for enabling the movement of the table top 206 along the vertical axis. The single cross bar assembly 210 converts a linear motion in a horizontal plane to a linear motion in a vertical plane. The table base 208 may be rigidly mounted on one end of the single cross bar assembly 210.

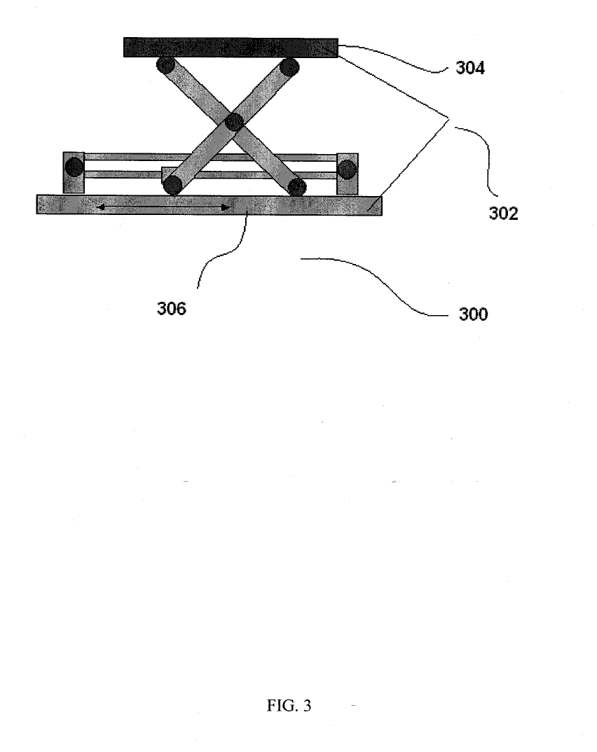

The table assembly 202 is said to be in a collapsed position when the distance between the table top 206 and the table base 208 along the vertical axis is minimum. FIG. 2 shows a schematic diagram of the patient positioning system 200 comprising the table assembly 202 in the collapsed position. Alternatively, the table assembly 202 can be in an extended position, when the distance between the table top 206 and the table base 208 along the vertical axis is maximum. FIG. 3 shows a schematic diagram of the patient positioning system 300 comprising the table assembly 302 in the extended position. In FIG. 3 the table top 304 and the table base 306 are at a maximum distance along the vertical axis. Further, the table assembly 302 can be configured to oscillate between the extended position and the collapsed position. A person skilled in the art will recognize that the collapsed and extended positions shown in FIGS. 2 and 3 are merely exemplary, and the position of the table top relative to table base may be higher or lower than that shown in either FIG. 2 or 3, and the angles formed by the intersecting cross bars of the cross bar assembly may be greater than or less than the angles shown in these figures. In one embodiment, the table top may abut or nearly abut the table base when the table assembly is in the collapsed position, with the cross bar assembly hidden therebetween.

The belt drive assembly 204 configured to drive the single cross bar assembly 210 comprises one or more geared motors (not shown). The geared motor (not shown) can be a stepper motor or a servomotor. A single geared motor (not shown) can be used along with other support accessories in a simple and effective way. The belt drive assembly 204 further comprises one or more timer belts 214 driven by the geared motor (not shown). One or more drive pulleys 216 and 217 can be mounted on the geared motor (not shown) to drive the timer belt 214.

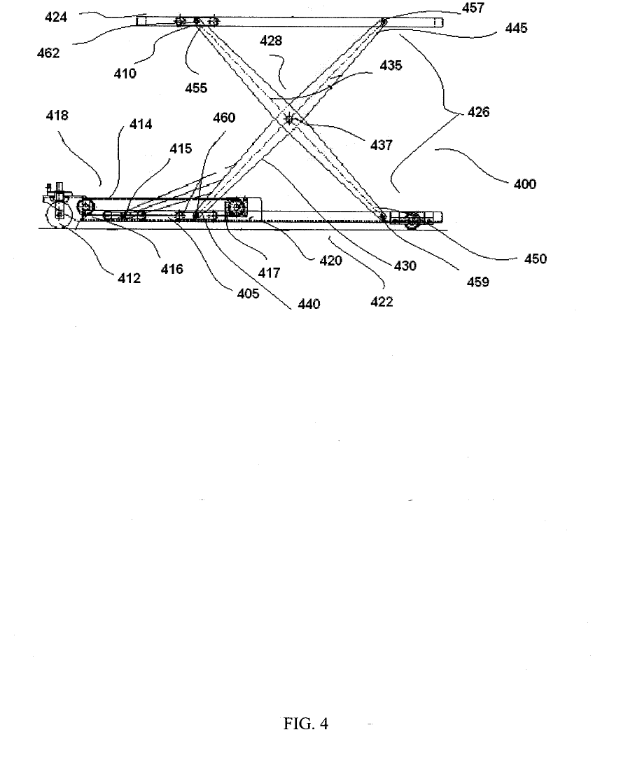

FIG. 4 shows a schematic diagram of patient positioning system 400 in yet another embodiment. In addition to the geared motor 412, the timer belt 414 and the drive pulleys 416 and 417, the belt drive assembly 418 comprises a first roller assembly 405 and a second roller assembly 410. The first roller assembly 405 is coupled to the table base 422 and the second roller assembly 410 is coupled to the table top 424. Each roller assembly 405 and 410 comprise multiple rollers 415 and a pair of support rails 420. The support rails 420 may be extended generally parallel to each other and between the opposing sides of the table assembly 426. The support rails 420 can be identical and can be manufactured through an extrusion process to reduce costs.

The support rails 420 are provided for co-operation during a longitudinal movement of the single cross bar assembly 428. The single cross bar assembly 428 may be slidably mounted on the first roller assembly 405. Structurally, the single cross bar assembly 428 comprises a pair of cross bars namely a first cross bar 430 and a second cross bar 435. The second cross bar 435 is movably coupled to the first cross bar 430 by a pivot 437. Further, each cross bar 430 and 435 in the single cross bar assembly 428 comprise a first end 440 and 450 and a second end 445 and 455.

The first end 440 of the first cross bar 430 is coupled to the timer belt 414 by a fastening device. One skilled in the art shall however appreciate that the timer belt 414 and the first cross bar 430 can be coupled to each other by similar techniques such as but not limited to a pivot and a hinge, and all such techniques lie within the scope of this embodiment of the invention. The timer belt 414 drives the first cross bar 430 of the single cross bar assembly 428 along the first roller assembly 405.

Further, the single cross bar assembly 428 consists of two rigidly held pivot points 457 and 459 and two robust sliding points 460 and 462. The first end 440 of the first cross bar 430 is coupled to the first roller assembly 405 via the first sliding point 460, where as the second end 445 of the first cross bar 430 is pivoted to the table top 424. Further, the first end 450 of the second cross bar 435 is pivoted to the table base 422, where as the second end 455 of the second cross bar 435 is coupled to the second roller assembly 410 via the second sliding point 462. One skilled in the art shall however appreciate that the patient positioning system 400 can comprise multiple single cross bar assemblies and each single cross bar assembly can be arranged in a substantially similar fashion to yield a collectively operable cross bar assembly. Further, multiple connections in each single cross bar assembly 428 can be varied in a complementary fashion to provide a substantially similar operation of the single cross bar assembly 428.

The belt drive assembly 418 when clubbed with the single cross bar assembly 428 provides flexibility to design a table assembly 426, which can be displaced to multiple positions along a vertical axis. Energization of the geared motor 412 imparts driving motion to the drive pulleys 416 and 417 causing the displacement of the timer belt 414. The linear motion of the timer belt 414 causes the single cross bar assembly 428 to move along a vertical axis. The movement of the single cross bar assembly 428 results in a vertical movement of the table assembly 426. Further, the direction of movement of the table assembly 426 along the vertical axis varies with the direction of rotation of the geared motor 412.

In an exemplary embodiment, the table assembly 426 and the belt drive assembly 418 may be configured such that a clockwise rotation of the geared motor 412 leads to the linear motion of the table assembly 426 in a vertically upward direction, whereas an anticlockwise rotation of the geared motor 412 leads to the linear motion of the table assembly 426 in a vertically downward direction. Thus, the rotary motion of the geared motor 412 causes the table assembly 426 to oscillate between the collapsed position (as shown at FIG. 2) and the extended position (shown at FIG. 3). The vertical displacement of the table assembly 426 is continuous as the movement of the single cross bar assembly 428 in the vertical plane is continuous. Thus the patient positioning system 400 provides an extra feature of continuously variable height of the table assembly 426.

In an embodiment, the belt drive assembly 418 can further comprise a clamping device. The clamping device can be placed along a longitudinal axis of the timer belt 414 to hold the table assembly 418 at a fixed position along the vertical axis. Providing the clamping device avoids unnecessary stressing of the timer belt 418 and the geared motor 412. Further, the clamping device imparts redundancy in displacing the table assembly 426 along the vertical axis.

In an exemplary embodiment, the belt drive assembly 418 comprises a timer belt 414 and two drive pulleys 416 and 417. One of the drive pulleys 416 and 417 is an idle pulley 416 and another is a driver pulley 417. A compact geared motor 412 coupled with an absolute encoder (not shown) drives the driver pulley 417. The driver pulley 417 drives the idle pulley 416 coupled through the timer belt 414. The linear motion of the timer belt 414 in a horizontal plane results in the linear motion of the table assembly 426 in a vertical plane. As a continuously variable belt drive assembly 418 drives the table assembly 426, the movement of the table assembly 426 along the vertical axis is continuous.

In one embodiment, the geared motor 412 can be a dual end shaft motor. Accordingly, two or more drive pulleys 416 and 417 can be placed beneath each end of the dual end shaft motor. The belt drive assembly 418 comprising the dual end shaft motor inherently takes care of the overhang issues. The dual end shaft motor nullifies the overhang effect as equal and opposite force act on both the ends of the dual end shaft motor. Thus, the rating of the double end shaft motor can be lower than the rating of the single end shaft motor.

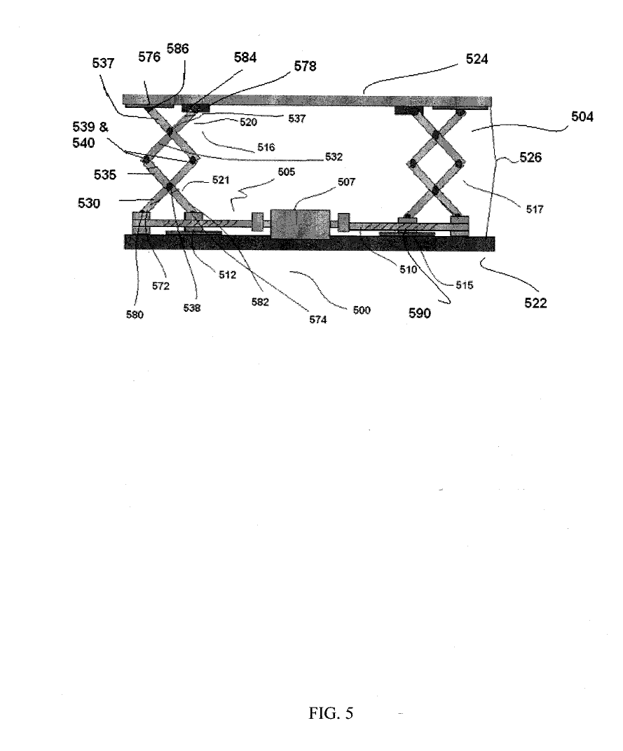

FIG. 5 shows a schematic diagram of a patient positioning system 500 comprising a table assembly 526 and a screw drive assembly 505 for driving the table assembly 526. The table assembly 526 comprises a table top 524 and a table base 522, wherein the screw drive assembly 505 can be firmly mounted on the table base 522. The screw drive assembly 505 generally includes an electric drive motor such as a dual end shaft motor 507, which is connected to a screw shaft 510 through a drive means, which utilize either a gear train or a drive belt. The screw shaft 510 may be a threaded screw shaft with a helical thread set at a given lead or pitch. Positioned on the threaded screw shaft 510 is a pair of drive nuts 512 and 515 each having a sliding block attached thereto. Each drive nut 512 and 515 may be rotated relative to the screw shaft 510 (or vice versa) to impart linear motion to either the drive nut 512 and 515 or the screw shaft 510. Further, the drive nuts 512 and 515 may be rotated in opposite directions relative to each other. As the drive nut 512 and 515 and the screw shaft 510 rotate relative to each other the sliding block attached to the drive nuts 512 and 515 move along a longitudinal axis of the screw shaft 510.

The patient positioning system 500 further comprises a cross bar assembly 504 comprising at least two multiple cross bar assemblies 516 and 517 for actuating the table assembly 526. Each multiple cross bar assembly 516 and 517 comprises multiple pair of cross bars 520 and 521 coupled to one another by pivots 539 and 540. Each pair of cross bars 520 and 521 comprises a first cross bar 530 and 532 and a second cross bar 535 and 537. Each of the first cross bar 530 and 532 and the second cross bar 535 and 537 comprise a first end and a second end.

In each multiple cross bar assembly 516 and 517, a pair of cross bars at one end of the multiple cross bar assembly 516 is referred as a first pair of cross bars 520 and a pair of cross bars at another end of the multiple cross bar assembly 516 is referred to as a second pair of cross bars 521. In the first pair of cross bars 520, the second cross bar 535 is movably coupled to the first cross bar 530 by a pivot 538. In the second pair of cross bars 521, the second cross bar 537 is movably coupled to the first cross bar 532 by a pivot 537. One skilled in the art shall however appreciate that the first cross bar 530 and 532 and the second cross bar 535 and 537 can be coupled to each other by similar techniques such as but not limited to a hinge, and all such techniques lie within the scope of the invention.

Further, one skilled in the art shall also appreciate that a cross bar assembly configured to drive the table assembly can comprise a plurality of multiple cross bar assemblies. Each multiple cross bar assembly can be structured and arranged in a substantially similar or complementary fashion to be collectively operable.

Each multiple cross bar assembly 516 and 517 comprises two support blocks 572 and 578 and two sliding blocks 574 and 576. The support blocks 572 and 578 are fixed at a single position and are not freely movable. The sliding blocks 574 and 576 translate the rotary motion of the screw shaft 510 into a linear motion, which actuates the multiple cross bar assembly 516 and 517 to move vertically.

A first support block 572 is pivoted to the screw shaft 510 and supports a free end of the screw shaft 510. A second support block 578 is pivoted to the table top 524. A first sliding block 574 is mounted on the drive nut 512 slidably engaged on the screw shaft 510 for a linear translation. A second sliding block 576 is movably coupled to the table top 524.

Further, each multiple cross bar assembly 516 and 517 comprises two fixed pivot points 580 and 584 and two sliding points 582 and 586. The first pair of cross bars 520 is coupled to the screw shaft 510 via a first pivot point 580 and a first sliding point 582. The second pair of cross bars 521 is coupled to the table top 524 via a second pivot point 584 and a second sliding point 586. More particularly, the first cross bar 530 of the first pair of cross bars 520 is coupled to the first support block 572 via the first pivot point 580. The second cross bar 535 of the first pair of cross bars 520 is coupled to the first sliding block 574 via the first sliding point 582. The first cross bar 532 of the second pair of cross bars 521 is coupled to the second support block 578 via the second pivot point 584. The second cross bar 537 of the second pair of cross bars 521 is coupled to the second sliding block 576 via the second sliding point 586.

The two multiple cross bar assemblies 520 and 521 in the patient positioning system 500 comprise the fixed pivot points 580 and 584 and the movable sliding points 582 and 586 arranged in a complementary fashion to each other, as shown in FIG. 5 to make the cross bar assembly operable. One skilled in the art shall however appreciate that the arrangement of the cross bar assembly is not restricted to the arrangement shown in FIG. 5 and each multiple cross bar assembly including the multiple pair of cross bars can be arranged in various other fashions, and those other fashions are covered within the scope of the invention.

Turning now to the operation of the patient positioning system 500, a rotation of the screw shaft 510 by the dual end shaft motor 507 causes the drive nuts 512 and 515 to move axially in order to impart axial motion to the connected sliding blocks 574 and 590. As the sliding blocks 574 and 590 move in the horizontal plane, the pair of cross bars 520 and 521 associated with the sliding blocks 574 and 590 move in a vertical plane. The movement of the cross bar assembly 504 along a vertical axis enables a displacement of the table top 524 with respect to the table base 522.

Clockwise rotation of the screw shaft 510 causes a linear movement of the connected drive nuts 512 and 515 in a direction axially opposite to each other. Further, an anticlockwise rotation of the screw shaft 510 results in an axial movement of each drive nut 512 and 515 in a direction opposite to that resulting from the clockwise rotation of the screw shaft 510. The table assembly 526 can be configured to move in upward direction or downward direction along the vertical axis, based on the rotation of the screw shaft 510. The table assembly 526 can thus be oscillated between the collapsed position and the extended position.

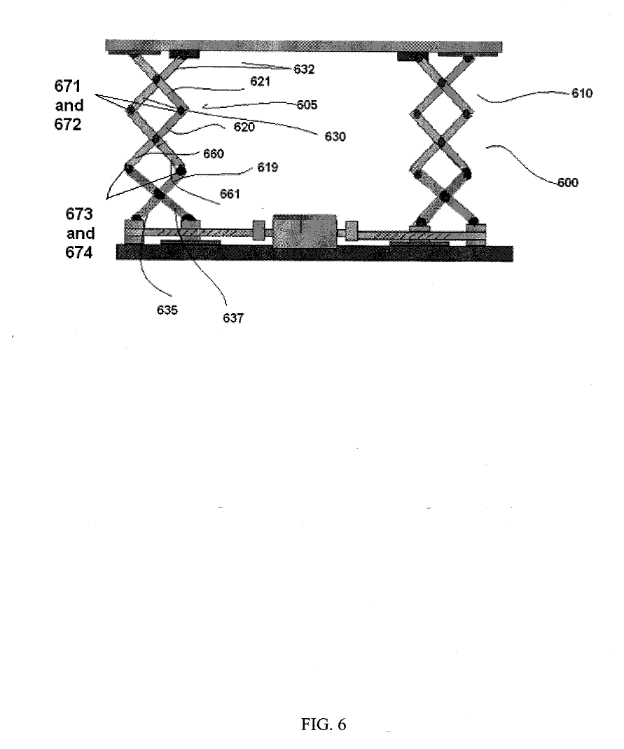

FIG. 6 shows an exemplary embodiment of a patient positioning system 600 comprising two multiple cross bar assemblies 605 and 610 that include three or more pair of cross bars 619, 620 and 621, each pair of cross bars positioned between the first pair of cross bars 619 and the second pair of cross bars 621 comprises two cross bars 660 and 661. The first end of each cross bars 660 and 661 are coupled to the adjacent pair of cross bars 630 and 632 by pivots 671 and 672. The second end of each cross bar 660 and 661 is coupled to another adjacent pair of cross bars 635 and 637 by pivots 673 and 674.

In yet another embodiment, a patient positioning system 400 or 500 comprising a table assembly 426 or 526 and at least one cross bar assembly 428 or 504 coupled to the table assembly 426 or 526 is provided. The cross bar assembly 428 or 504 is positioned between the table top 424 or 524 and the table base 422 or 522 of the table assembly 426 or 526. The cross bar assembly 428 or 504 comprises a single cross bar assembly 428 or two multiple cross bar assemblies 516 and 517. The single cross bar assembly 428 comprises a pair of cross bars 430 and 435. Each multiple cross bar assembly 516 and 517 comprises multiple pair of cross bars 520 and 521 coupled to one another by pivots 539 and 540. Each pair of cross bars 520 and 521 comprises a first cross bar 530 and 532 and a second cross bar 535 and 537 movably coupled to each other by a pivots 538 and 537. Further each cross bar 530, 532, 535 and 537 in the pair of cross bars 520 and 521 comprises a first end and a second end.

Each cross bar assembly 428 or 504 comprises multiple hinge points. The multiple hinge points provide an increased flexibility in assembly errors and manufacturing tolerances. Additionally, the multiple hinge points aid in reducing an initial collapsible height of the table assembly 426 or 526. The initial collapsible height of the table assembly 426 or 526 is the height of the table assembly 426 or 526 in a collapsed position.

The patient positioning system 400 or 500 further comprises one of a belt drive assembly 418 and a screw drive assembly 505 configured to drive the table assembly 426 or 526. The screw drive assembly 505 and the belt drive assembly 418 are rotary-to-linear motion converters, configured for driving the cross bar assembly 428 or 504.

The belt drive assembly 418 can comprise one or more geared motors 412. One or more timer belts 414 can be coupled to the geared motor 412. The timer belt 414 imparts the requirement of linear motion of the cross bar assembly 428 or 504 with an increased flexibility. The timer belt 414 coupled to the geared motor 412 is driven through a coupling device such as an electro mechanical clutch (not shown). The timer belt 414 is coupled to the first end 440 of the first cross bar 430 by a fastening device (not shown).

The timer belt 414 at one end is supported by a drive pulley 416, which is coupled to a brake device (not shown) such as an electro mechanical brake to arrest the motion of the timer belt 414 at a required position. The belt drive assembly 418 and the table assembly 426 or 526 can be configured such that, arresting the motion of the timer belt 414 at a predetermined point along the longitudinal axis results in displacing the table assembly 426 or 526 to a predetermined position along the vertical axis.

The belt drive assembly 418 further comprises a first roller assembly 405 coupled to the table base 422 or 522 and a second roller assembly 410 coupled to the table top 424 or 524. Each roller assembly 405 and 410 comprises multiple rollers 415 and a pair of support rails 420. The support rails 420 can be extended generally parallel to each other and between the opposing sides of the table assembly 426 or 526. The support rails 420 can be made from a relatively lightweight, inexpensive, yet rigid and strong material such as aluminum.

Each single cross bar assembly 428 comprises two fixed points 457 and 459 and two sliding points 460 and 462. In an exemplary embodiment, the first end 440 of the first cross bar 430 is coupled to the first roller assembly 405 via the first sliding point 460. The second end 445 of the first cross bar 430 is pivoted to the table top 424 or 524 via the first pivot point 457 and the first end 450 of the second cross bar 435 is pivoted to the table base 422 or 522 via the second pivot point 459. The second end 455 of the second cross bar 435 is coupled to the second roller assembly 410 via the second sliding point 462.

Operation of the geared motor 412 causes rotation of the drive pulleys 416 and 417. The drive pulleys 416 and 417 drive the timer belt 414 extending between the driver pulley 416 and the idle pulley 417, causing a linear motion of the timer belt 414. The linear motion of the timer belt 414 translates into vertical movement of the cross bar assembly 428 or 504. The vertical movement of the cross bar assembly 428 or 504 causes the displacement of the table top 424 or 524 along a vertical axis. Thus the operation of the geared motor 412 results in a continuous movement of the table assembly 426 or 526 along a vertical axis.

The force applied on the belt drive assembly 418 is minimum as the force is applied at locations requiring an optimum force. The application of an external force and unnecessary stresses generated there from can thus be eliminated.

The screw drive assembly 505 used as an alternative to the belt drive assembly 418 comprises one or more dual end shaft motors 507. The dual end shaft motor 507 can be a servomotor comprising shafts that extend outwardly in opposite directions. The screw drive assembly 505 further comprises a screw shaft actuator coupled to the dual end shaft motor 507. The screw shaft actuator comprises a screw shaft 510 coupled to the dual end shaft motor 507 and two or more drive nuts 512 and 515 movably coupled to the screw shaft 510.

Each multiple cross bar assembly 516 and 517 comprises two rigidly held support blocks 572 and 578 and two movable sliding blocks 574 and 576. A first support block 572 is coupled to the screw shaft 510 and a first sliding block 574 is coupled to a first drive nut 512 driven by the screw shaft 510. A second support block 578 is coupled to the table top 424 or 524 and a second sliding block 576 is movably coupled to the table top 424 or 524. Two multiple cross bar assemblies 516 and 517 can be arranged in a fashion complementary each other in order to make the cross bar assembly 428 or 504 operable.

In an exemplary embodiment, the first cross bar 530 of a first pair of cross bars 520 is coupled to the first support block 572 via a first pivot point 580. The second cross bar 535 of the first pair of cross bars 520 is coupled to the first sliding block 574 via a first sliding point 582. Further the first cross bar 532 of a second pair of cross bars 521 is coupled to the second support block 578 via a second pivot point 586. The second cross bar 537 of the second pair of cross bars 521 is coupled to the second sliding block 576 via a second sliding point 584.

Rotation of the screw shaft 510 by the dual end shaft motor 507 causes the drive nuts 512 and 515 to move axially in order to impart linear motion to the connected cross bars. The linear movement of the cross bars along the longitudinal axis results in the linear movement of the connected cross bar assembly 428 or 504 along the vertical axis. As the movement of the cross bar assembly 428 or 504 is continuous, the displacement of the table top 424 or 524 coupled to the cross bar assembly 428 or 504 is continuous.

Some of the advantages of the patient positioning system provided in various embodiments include cost reduction, provision of continuously variable height and reduction in initial collapsible height of the table assembly. The belt drive assembly and the screw drive assembly provide a cost effective solution to attain a vertical displacement without compromising on the specifications.

The initial collapsible height of the table assembly is small compared to the prior art actuators. Several hinge points provided in the cross bar assembly aid in reducing the initial collapsible height of the table assembly and provide increased flexibility in assembly errors and manufacturing tolerances.

The belt drive assembly used in the patient positioning system is simpler and compact compared to a conventional hydraulic drive system. Components such as timer belts and drive pulleys used in the belt drive assembly are easily available at a nominal cost. Critical components used in the belt drive assembly are bought out components and hence replacement or repair cost is reduced significantly. Therefore, the cost savings are reduced greatly when compared to a hydraulic drive system.

The manufacturing and production of the belt drive assembly is simple when compared to the hydraulic drive system. The belt drive assembly requires less assembly time and can be accommodated easily due to the flexibility of the timer belt used in the belt drive assembly. Therefore the manufacturing, assembling, transport and handling of the belt drive assembly is simple, cheap and reliable.

The belt drive assembly when clubbed with the cross bar assembly enables a continuous movement of the table top along a vertical axis. The continuous movement of the table top results in a continuously variable height of the table assembly.

On the other hand, a patient positioning system comprising the screw drive assembly is simpler in transporting, storing, handling, assembling and aligning, compared to the hydraulic drive system.

The screw drive assembly along with the cross bar assembly enables the table assembly to be displaced to multiple positions along a vertical axis when compared to a hydraulic drive system where the movement of the table assembly is restricted to two positions namely a collapsed position and an extended position. Additionally, the screw drive assembly reduces the initial collapsible height of the table assembly when compared to the hydraulic drive system.

The screw shaft actuator provided in one embodiment enables upgrading a patient positioning system comprising a hydraulic cylinder. The hydraulic cylinder being expensive can be replaced at ease with the screw shaft actuator. The patient positioning system can be utilized without significant alterations, by replacing the hydraulic cylinder with the screw shaft actuator. Further, the screw shaft actuators are independent of the constraints such as load, displacement and minimum collapsible height.

In various embodiments of the invention, a patient positioning system for an imaging device and an imaging device using a patient positioning system are described. However, the embodiments are not limited and may be implemented in connection with different applications such as displacement applications. The application of the invention can be displaced to other areas, for example positioning devices. The invention provides a broad concept of a rotary motion translating to a linear motion application, which can be adapted in a similar positioning device. The design can be carried further and implemented in various forms and specifications.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A patient positioning system for an imaging device, the patient positioning system comprising:
a table assembly for engaging and supporting a patient, wherein the table assembly is configured to be displaced to multiple positions along a vertical axis;
at least one cross bar assembly coupled to the table assembly; and
a belt drive assembly coupled to the cross bar assembly, wherein the belt drive assembly is configured to drive the cross bar assembly.

2. The patient positioning system of claim 1, wherein the table assembly comprises:
a table top; and
a table base.

3. The patient positioning system of claim 2, wherein the cross bar assembly comprises:
a first cross bar; and
a second cross bar movably coupled to the first cross bar by a pivot.

4. The patient positioning system of claim 3, wherein the first cross bar and the second cross bar each comprises a first end and a second end, and the second end of the first cross bar is pivoted to the table top and the first end of the second cross bar is pivoted to the table base.

5. The patient positioning system of claim 1, wherein the belt drive assembly comprises:
at least one geared motor;
at least two drive pulleys coupled to the geared motor; and
at least one timer belt coupled to the drive pulleys.

6. The patient positioning system of claim 5, wherein the cross bar assembly comprises a first cross bar and a second cross bar movably coupled to the first cross bar by a pivot, the first cross bar and the second cross bar each comprises a first end and a second end, and the first end of the first cross bar is coupled to the timer belt by a fastening device.

7. The patient positioning system of claim 5, wherein the table assembly comprises a table top and a table base, and the belt drive assembly further comprises:
a first roller assembly coupled to the table base; and
a second roller assembly coupled to the table top;
wherein each roller assembly comprises multiple rollers and a pair of support rails, the support rails being extended generally parallel to each other and between the opposing sides of the table assembly.

8. The patient positioning system of claim 7, wherein the cross bar assembly comprises a first cross bar and a second cross bar movably coupled to the first cross bar, the first cross bar and the second cross bar each comprises a first end and a second end, and the first end of the first cross bar is coupled to the first roller assembly via a first sliding point and the second end of the second cross bar is coupled to the second roller assembly via a second sliding point.

9. A patient positioning system for an imaging device, the patient positioning system comprising:
a table assembly for engaging and supporting a patient, wherein the table assembly is configured to be displaced to multiple positions along a vertical axis;
at least two multiple cross bar assemblies coupled to the table assembly; and
a screw drive assembly coupled to the multiple cross bar assemblies, wherein the screw drive assembly is configured to drive the multiple cross bar assemblies.

10. The patient positioning system of claim 9, wherein the table assembly comprises:
a table top; and
a table base.

11. The patient positioning system of claim 10, wherein each multiple cross bar assembly comprises multiple pairs of cross bars, wherein each pair of cross bars is coupled to another pair of cross bars by a pivot.

12. The patient positioning system of claim 11, wherein each pair of cross bars comprises:
a first cross bar; and
a second cross bar movably coupled to the first cross bar by a pivot.

13. The patient positioning system of claim 12, wherein the screw drive assembly comprises:
a dual end shaft motor;
a screw shaft coupled to the dual end shaft motor; and
at least two drive nuts movably coupled to the screw shaft.

14. The patient positioning system of claim 13, wherein each multiple cross bar assembly comprises:
a first support block coupled to the screw shaft;
a first sliding block coupled to a first drive nut driven by the screw shaft,
a second support block coupled to the table top; and
a second sliding block movably coupled to the table top.

15. The patient positioning system of claim 14, wherein the first cross bar of a first pair of cross bars is coupled to the first support block via a first pivot point.

16. The patient positioning system of claim 15, wherein the second cross bar of the first pair of cross bars is coupled to the first sliding block via a first sliding point.

17. The patient positioning system of claim 14, wherein the first cross bar of a second pair of cross bars is coupled to the second support block via a second pivot point.

18. The patient positioning system of claim 17, wherein the second cross bar of the second pair of cross bars is coupled to the second sliding block via a second sliding point.

19. A patient positioning system comprising:
a table assembly for engaging and supporting a patient, wherein the table assembly is configured to be displaced to multiple positions along a vertical axis;
at least one cross bar assembly coupled to the table assembly; and
at least one drive assembly coupled to the cross bar assembly, the drive assembly being configured to drive the cross bar assembly, the drive assembly being selected from the group consisting of a belt drive assembly and a screw drive assembly.

20. The patient positioning system of claim 19, wherein the table assembly comprises:
a table top; and
a table base.

21. The patient positioning system of claim 20, wherein the cross bar assembly is selected from the group consisting of
at least one single cross bar assembly comprising a pair of cross bars and at least two multiple cross bar assemblies, each multiple cross bar assembly comprising multiple pairs of cross bars, wherein each pair of cross bars is coupled to another pair of cross bars by a pivot.

22. The patient positioning system of claim 21, wherein each pair of cross bars comprises:
a first cross bar; and
a second cross bar movably coupled to the first cross bar by a pivot, wherein the first cross bar and the second cross bar comprise a first end and a second end.

23. The patient positioning system of claim 22, wherein the second end of the first cross bar is pivoted to the table top and the first end of the second cross bar is pivoted to the table base.

24. The patient positioning system of claim 22, wherein the belt drive assembly comprises:
at least one geared motor;
at least two drive pulleys coupled to the geared motor; and
at least one timer belt coupled to the drive pulleys.

25. The patient positioning system of claim 24, wherein the first cross bar of a first pair of cross bars is coupled to the timer belt by a fastening device.

26. The patient positioning system of claim 24, wherein the belt drive assembly further comprises:
a first roller assembly coupled to the table base; and
a second roller assembly coupled to the table top, each roller assembly comprising multiple rollers and a pair of support rails, the support rails being extended generally parallel to each other and between the opposing sides of the table assembly.

27. The patient positioning system of claim 26, wherein the first end of the first cross bar is coupled to the first roller assembly via a first sliding point and the second end of the second cross bar is coupled to the second roller assembly via a second sliding point.

28. The patient positioning system of claim 22, wherein the screw drive assembly comprises:
a dual end shaft motor;
a screw shaft coupled to the dual end shaft motor; and
at least two drive nuts movably coupled to the screw shaft.

29. The patient positioning system of claim 28, wherein each multiple cross bar assembly comprises:
a first support block coupled to the screw shaft;
a first sliding block coupled to a first drive nut driven by the screw shaft;
a second support block coupled to the table top; and
a second sliding block movably coupled to the table top.

30. The patient positioning system of claim 29, wherein the first cross bar of a first pair of cross bars is coupled to the first support block via a first pivot point.

31. The patient positioning system of claim 30, wherein the second cross bar of the first pair of cross bars is coupled to the first sliding block via a first sliding point.

32. The patient positioning system of claim 29, wherein the first cross bar of a second pair of cross bars is coupled to the second support block via a second pivot point.

33. The patient positioning system of claim 32, wherein the second cross bar of the second pair of cross bars is coupled to the second sliding block via a second sliding point.
